(19) United States
(12) Patent Application Publication
(10) Pub. No.: US 2026/0225402 A1
(43) Pub. Date: Aug. 6, 2026

(54) SULPHUR-CROSSLINKABLE RUBBER MIXTURE, VULCANISATE OF THE RUBBER MIXTURE, AND VEHICLE TYRE

(71) Applicant: Continental Reifen Deutschland GmbH, Hannover (DE)

(72) Inventor: Christian Weber, Garbsen (DE)

(73) Assignee: Continental Reifen Deutschland GmbH, Hannover (DE)

(21) Appl. No.: 19/152,946

(22) PCT Filed: Jan. 18, 2024
(86) PCT No.: PCT/DE2024/035005

§ 371 Date: Aug. 1, 2025

(30) Foreign Application Priority Data
Feb. 22, 2023 (DE) 10 2023 201 616.8

(51) Int. Cl. B60C 1/00; C08K 3/04; C08K 3/06; C08K 3/22; C08K 3/36; C08K 5/00; C08K 5/09; C08K 5/13; C08K 5/372; C08K 5/548; C08L 7/00

(52) U.S. Cl. CPC B60C 1/00; C08K 3/04; C08K 3/06; C08K 3/22; C08K 3/36; C08K 5/0016; C08K 5/0025; C08K 5/09; C08K 5/13; C08K 5/372; C08K 5/548; C08L 7/00; C08K 2003/2296

(57) ABSTRACT

A sulfur-crosslinkable rubber mixture, to the vulcanizate thereof, and to a vehicle tire. The sulfur-crosslinkable rubber mixture comprises at least the following constituents: 50 to 100 phr of natural polyisoprene (NR), 0 to 50 phr of at least one further diene rubber, 5 to 80 phr of at least one rubber regenerate produced using at least one regenerating agent selected from the group consisting of dithiophosphoryl polysulfides and silanes having a polysulfane group from a rubber mixture produced in an internal mixer, where the rubber mixture includes at least 50% by weight of comminuted treads of radial HGV tires and/or radial bus tires, 1 to 30 phr of at least one tackifier resin, and 50 to 100 phr of at least one filler.

The invention relates to a sulfur-crosslinkable rubber mixture, to the vulcanizate thereof, and to a vehicle tire.

The rubber composition of the tread determines to a large extent the driving characteristics of a vehicle tire, particularly those of a pneumatic vehicle tire.

The rubber mixtures which find use particularly in the parts of drive belts, hoses, and belts that are subject to severe mechanical stress are substantially responsible for the stability and long life of these rubber articles. Therefore, very high demands are made on these rubber mixtures for pneumatic vehicle tires, belts, drive belts, and hoses.

There are trade-offs between most of the known tire properties, such as wet grip characteristics, braking characteristics, handling characteristics, rolling resistance, winter properties, abrasion characteristics, and friction properties.

Particularly in the case of pneumatic vehicle tires, various attempts have been made to positively influence these properties of the tire by varying the polymer components, the fillers, and the other additives. In this context, it has to be taken into account that an improvement in one tire property often entails a deterioration in another property.

In addition to the abovementioned objectives with regard to the properties of the mixture and of the vulcanizate, efforts are nowadays being made to reduce dependence on fossil raw materials and to minimize greenhouse gas emissions. In designing production processes with greater sustainability, the recycling of old products that are no longer required is becoming increasingly important. In many areas of technology these “secondary” raw materials are already allowing savings to be achieved in the materials used for production that improve the sustainability of production and of the products thus produced.

For example, it is known from the prior art that rubber materials from old conveyor belts or used tires can be processed for use as an added material in vulcanizable rubber mixtures, which can then undergo forming in the course of the production of tires or other rubber products and vulcanization to the desired rubber products. These rubber “regenerates” can in principle be produced in various ways. In particular, prepared materials are known from the prior art in which, although still a rubber material in the narrower sense, i.e. crosslinked rubber, the plasticity thereof is adjusted to that of unvulcanized rubber by means of suitable treatment methods, in particular by employing thermochemical stressing and chemicals. A process for producing rubber regenerate using special regenerating agents is described for example in DE 10 2012 108 096 A1. In addition, there are rubber regenerates in which there is at least partial devulcanization, i.e. the breaking of chemical linkages in the rubber material, and in which the depolymerization of the previously crosslinked rubber material contributes accordingly to an increase in plasticity.

The production of rubber regenerates from rubber materials employs various technologies and processes, for example steam regeneration, mechanical regeneration, thermal regeneration, sound-wave-based regeneration, radiation-based regeneration, chemical regeneration, and combinations of these methods.

Since these processes for the production of rubber regenerates are being applied to structurally highly complex, disordered, and inherently non-structurally describable starting materials and induce very different physicochemical changes therein depending on the processes and process parameters employed, the different rubber regenerates exhibit very different properties depending on the rubber materials originally used, the chemical composition of which varies depending in particular on the nature of the recycled rubber products and the method used for devulcanization.

When using different rubber regenerates in vulcanizable rubber mixtures, especially in the field of tire production with the prevailing profusion of very different requirement profiles in this sector, there is therefore often a trade-off between adding the largest possible amount of rubber regenerate and at the same time achieving the best-possible performance characteristics, which preferably should not differ from those obtained for vulcanizable rubber mixtures from primary raw materials.

When rubber regenerate is used in mixtures containing a high proportion of natural rubber, a deterioration in the crack resistance and heat buildup of the vulcanizates can for example occur.

The object of the present invention is to provide a rubber mixture containing a proportion of rubber regenerate, the vulcanizates of which exhibit a high crack resistance and low heat buildup.

This object is achieved by a rubber mixture comprising at least the following constituents:
50 to 100 phr (parts by weight, based on 100 parts by weight of all rubbers in the mixture) of natural polyisoprene,
0 to 50 phr of at least one further diene rubber,
5 to 80 phr of at least one rubber regenerate produced using at least one regenerating agent selected from the group consisting of dithiophosphoryl polysulfides and silanes having a polysulfane group from a rubber mixture produced in an internal mixer, where the rubber mixture consists of at least 50% by weight of comminuted treads of radial HGV tires and/or radial bus tires,
1 to 30 phr of at least one tackifier resin, and
50 to 100 phr of at least one filler.

Surprisingly, it has been found that the combination of the special rubber regenerate with a tackifier resin in mixtures containing a high proportion of natural polyisoprene can be used to obtain regenerate-containing rubber mixtures that, despite a proportion of regenerate, are characterized by good mixture and vulcanizate properties, particularly with regard to crack resistance and heat buildup. It was found that an improvement in the crack resistance and heat buildup of the vulcanizates can be achieved only when using the special rubber regenerate produced using at least one regeneration agent selected from the group consisting of dithiophosphoryl polysulfides and silanes having a polysulfane group from a rubber mixture in an internal mixer consisting of more than 50% by weight of comminuted treads of radial HGV tires and/or radial bus tires. With other rubber regenerates that had been produced for example by thermomechanical devulcanization in an autoclave and/or with other regenerating agents, these property profiles could not be achieved by the interplay with the resin.

The rubber mixture of the invention also offers the advantage that the proportion of rubber regenerate makes it possible to reduce the need for primary raw materials, thereby greatly improving the sustainability of the production of corresponding rubber products. To increase the sustainability of the production process, the production of the rubber regenerate is ideally carried out without the use of substances potentially harmful to the environment or to health in a time- and cost-efficient manner and with the lowest possible energy consumption.

The invention encompasses all of the advantageous configurations reflected inter alia in the claims. The invention in particular also encompasses configurations that result from combination of different features, for example of constituents of the rubber mixture, with different levels of preference for these features, such that the invention also encompasses a combination of a first feature described as “preferred” or feature described in the context of an advantageous embodiment with a further feature described for example as “particularly preferred”.

The present invention further provides a vulcanizate of at least one rubber mixture of the invention.

The present invention further provides a vehicle tire which comprises at least one vulcanizate of the invention of the rubber mixture of the invention in at least one component. It is preferable when the vehicle tire comprises at least one vulcanizate of the invention at least in the tread, especially in the tread base.

The vulcanizate of the invention and the vehicle tire of the invention are characterized by an optimized profile of crack resistance and rolling resistance properties, since a low heat buildup can be correlated with a low rolling resistance. The durability of the tire is improved.

In the case of two-part treads (upper part: cap and lower part: base), the rubber mixture of the invention can be used both for the cap and for the base. It is preferable when at least the base comprises at least one vulcanizate of the invention of the rubber mixture of the invention.

In the context of the present invention, “vehicle tires” are understood as meaning pneumatic vehicle tires and all-rubber tires, including tires for industrial site and construction site vehicles, HGV tires, car tires, and two-wheeled vehicle tires.

The rubber mixture of the invention is moreover also suitable for other components of vehicle tires, for example the flange profile in particular, and also for inner tire components. The rubber mixture of the invention is moreover also suitable for other industrial rubber articles, such as bellows, conveyor belts, air springs, belts, drive belts or hoses, and also footwear soles.

There follows a detailed description of the constituents of the sulfur-crosslinkable rubber mixture of the invention. All observations are equally applicable to the vulcanizate of the invention and to the vehicle tire of the invention that includes at least one vulcanizate of the invention of the rubber mixture of the invention in at least one component.

The unit “phr” (parts per hundred parts of rubber by weight) used in this document is the standard unit of amount for mixture formulations in the rubber industry. In this document, the dosage of the parts by weight of the individual substances is based on 100 parts by weight of the total mass of all (primary) rubbers present in the mixture that have a molecular weight M_{w} by GPC of greater than 20 000 g/mol. These rubbers having a molecular weight of more than 20 000 g/mol are referred to as high-molecular-weight rubbers. The rubber regenerates are not included here in the total mass of the high-molecular-weight rubbers employed as primary raw materials. Accordingly, in the context of the present invention, the mass fraction of the high-molecular-weight rubbers employed as primary raw material in the rubber mixture, i.e. the rubbers that do not originate from a rubber regenerate, add up to 100 phr.

According to the invention, the rubber mixture contains 50 to 100 phr of natural polyisoprene (NR). Natural polyisoprene, also termed natural rubber, is understood as meaning rubber that can be obtained by harvesting from natural sources such as rubber trees (Hevea brasiliensis) or non-rubber tree sources (for example guayule or dandelion (e.g. Taraxacum koksaghyz)). Natural polyisoprene (NR) is understood as meaning nonsynthetic polyisoprene.

The rubber mixture of the invention further contains 0 to 50 phr at least one further diene rubber that is not natural polyisoprene. Diene rubbers are rubbers formed by polymerization or copolymerization of dienes and/or cycloalkenes and thus have C═C double bonds either in the main chain or in the side groups.

The further diene rubber(s) is/are preferably selected from the group consisting of synthetic polyisoprene (IR), epoxidized polyisoprene (ENR), butadiene rubber (BR), butadiene-isoprene rubber, and styrene-butadiene rubber (SBR), in particular solution-polymerized styrene-butadiene rubber (SSBR) and emulsion-polymerized styrene-butadiene rubber (ESBR), styrene-isoprene rubber, liquid rubbers having a molecular weight M_{w} of more than 20 000 g/mol, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile butadiene rubber, and hydrogenated styrene-butadiene rubber.

Nitrile rubber, hydrogenated acrylonitrile-butadiene rubber, chloroprene rubber, butyl rubber, halobutyl rubber or ethylene-propylene-diene rubber in particular are used in the production of industrial rubber articles, such as belts, drive belts, and hoses, and/or footwear soles. The mixture compositions known to those skilled in the art for these rubbers, which are specific in terms of fillers, plasticizers, vulcanization systems, and additives, are used with preference here.

In a particularly preferred embodiment of the invention, the diene rubber(s) is/are selected from the group consisting of synthetic polyisoprene (IR), butadiene rubber (BR), solution-polymerized styrene-butadiene rubber (SSBR), and emulsion-polymerized styrene-butadiene rubber (ESBR). A rubber mixture of this kind is especially suitable for tread parts of vehicle tires.

The rubber mixture for a balanced property profile preferably contains 60 to 90 phr of natural polyisoprene (NR) and 10 to 40 phr of at least one further diene rubber. It is clear to those skilled in the art that the amounts of solid rubbers add up to 100.

For a low heat buildup in the vulcanizate, the further diene rubber in amounts of 10 to 40 phr is butadiene rubber (BR).

If BR or SSBR is used in the rubber mixture, these can be modified with functionalizations as end groups and/or along the polymer chains. The terms “functionalization” and “modification” are used synonymously.

The modifications may be selected from ones having hydroxyl groups and/or ethoxy groups and/or epoxy groups and/or siloxane groups and/or amino groups and/or aminosiloxane and/or carboxyl groups and/or phthalocyanine groups and/or silane-sulfide groups.

However, other functionalizations known to those skilled in the art are also suitable. Metal atoms may be a constituent of such functionalizations.

In particular, the rubbers may be functionalized with groups that permit attachment to silica as a filler for the rubber mixture.

It is essential to the invention that the rubber mixture contains 5 to 80 phr, preferably 5 to 40 phr, of at least one rubber regenerate produced using at least one regenerating agent selected from the group consisting of dithiophosphoryl polysulfides and silanes having a polysulfane group from a rubber mixture in an internal mixer, where the rubber mixture consists of at least 50% by weight of comminuted treads of radial HGV tires and/or radial bus tires. It is also possible to use two or more rubber regenerates in the mixture.

According to a preferred embodiment of the invention, the dithiophosphoryl polysulfide has the general formula I

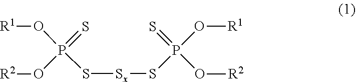

where R¹ and R² are identical or different and are selected from linear or branched C₃ to C₂₀ alkyl radicals and x=1 to 6.

Particularly preferably, the dithiophosphoryl polysulfide is a bis(O,O-2-ethylhexylthiophosphoryl) polysulfide.

According to a preferred embodiment of the invention, at least one silane having a polysulfane group of the general formula II or a mixture comprising at least one silane having a polysulfane group of the following general formula II is used as regenerating agent:

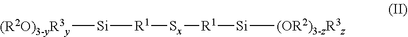

where x=1 to 8 and where the R¹ in a molecule are identical or different and are selected from linear or branched C₁ to C₁₈ alkyl radicals, where the R² and R³ in a molecule are identical or different and are selected from linear or branched or cyclic saturated C₁ to C₃₀ alkyl radicals, and where y and z are identical or different and 0 to 3.

The number of hydrogen atoms in the alkyl radicals is determined by the number of carbon atoms.

Preferably, x=1 to 5, more preferably x=2 to 4 and in a very particularly preferred embodiment x=4.

According to a particularly preferred development, the silane having a polysulfane group is a bis(trialkoxysilyl)propyl polysulfane, where z=0, R¹ is a propyl radical, and R² is an alkyl radical having 1 to 30 carbon atoms. This silane has the general constitutional formula III

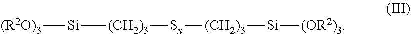

Very particularly preferably, the radical R² is an ethyl group, which means that the silane having a polysulfane group is a bis(triethoxysilyl) propyl polysulfane.

According to a further preferred development of this embodiment of the invention, the radicals R² and/or R³ of the silane having a polysulfane group additionally contain 1 to 10 nitrogen atoms (N) and/or oxygen atoms (O) as heteroatoms in the carbon chain. According to this development of the invention, it is conceivable that the radicals R² and/or R³ are for example a unit having the constitutional formula IV

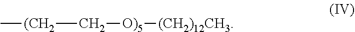

In this case, the radicals R² and/or R³ contain five oxygen atoms as heteroatoms.

In a further embodiment of the invention, the silane having a polysulfane group has the general formula V

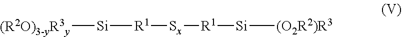

where x=1 to 8 and where the R¹ in a molecule are identical or different and are selected from linear or branched C₁ to C₁₈ alkyl radicals, where the R² in a molecule are identical or different and are selected from linear or branched or cyclic saturated C₁ to C₃₀ alkyl radicals, and where y and z are identical or different and 0 to 3 and where the R³ in a molecule are identical or different and are selected from linear or branched C₁ to C₁₀ alkyl or alkoxy radicals.

In this embodiment, a radical R² can bridge two oxygen atoms together.

In a further embodiment of the invention, the silane having a polysulfane group has the general formula VI

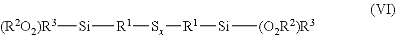

where x=1 to 8 and where the R¹ in a molecule are identical or different and are selected from linear or branched C₁ to C₁₈ alkyl radicals, where the R² in a molecule are identical or different and are selected from linear or branched or cyclic saturated C₁ to C₃₀ alkyl radicals, and where the R³ in a molecule are identical or different and are selected from linear or branched C₁ to C₁₀ alkyl or alkoxy radicals.

In this embodiment, a radical R² at either end of the molecule can bridge two oxygen atoms together.

Preferably, the regenerating agent is selected from bis(O,O-2-ethylhexylthiophosphoryl) polysulfide and/or (bis(triethoxysilyl)propyltetrasulfane (TESPT)). The substances may be used individually or in a mixture.

The rubber regenerate employed according to the invention can be obtained for example by the following mild breakdown process comprising at least the following process steps:
charging an internal mixer with the sulfur-crosslinked rubber mixture to be regenerated in amounts of 68% to 98% by weight and
heating the sulfur-crosslinked rubber mixture to be regenerated to 50 to 70° C. and
adding at least one dithiophosphoryl polysulfide and/or at least one silane having a polysulfane group in amounts of 2% to 15% by weight and
mixing said constituents into a mixture over a period of 5 to 35 minutes at a temperature of 80 to 150° C.

Processes for producing employable rubber regenerates for the invention are described for example in DE 10 2012 108 096 A1.

Rubber materials used in different rubber products frequently have very different physicochemical and mechanical properties, this being due in particular to the chemical composition of the vulcanizable rubber mixtures used for production. The rubber materials accordingly behave differently in regenerate production and result in chemically different rubber regenerates. The choice of starting material is thus in practice of key importance. The inventors in the present case have found that rubber materials from the treads of radial tires for HGVs and buses, which are characterized by a use-typical property profile, have particularly high compatibility with the process for producing the regenerate and the resulting rubber regenerates are particularly suitable for use in vulcanizable rubber mixtures having a high proportion of natural polyisoprene.

For maximally sustainable production of the rubber mixture of the invention, the rubber mixture consists of at least 50% by weight, preferably at least 70% by weight, more preferably essentially 100% by weight, of comminuted treads of recycled radial HGV tires and/or recycled radial bus tires, based on the mass of the rubber mixture. Recycled tires mean that the tires have had prior use and are accordingly at least partially worn.

The rubber mixture preferably contains no detectable residues of butyl or halobutyl rubbers and not more than 0.01% by weight of fiber residues.

According to the invention, the rubber mixture contains 1 to 30 phr, preferably 2.5 to 10 phr, of at least one tackifier resin. It is also possible to employ two or more resins in the mixture. “Tackifier resins” are understood as meaning resins used in rubber mixtures to increase the tackiness of the mixture. Such tackifier resins, also known as adhesive resins, are known to those skilled in the art, for example from J. Schnetger, Lexikon der Kautschuktechnik [Dictionary of rubber technology], Hüthig Verlag Heidelberg, 3rd edition, p. 211, under the keyword “Resins”.

According to an advantageous development of the invention, the tackifier resin(s) has/have a ring and ball softening point in accordance with DIN 52011 of from 50 to 160° C., preferably from 125 to 160° C. This achieves a good level of crack resistance alongside low heat buildup.

According to the invention, a wide variety of adhesive resins known to those skilled in the art can be used. Preferably, the tackifier resin(s) is/are selected from the group consisting of aliphatic hydrocarbon resins, phenolic resins, terpene resins, terpene-phenol resins, AMS resins, coumarone-indene resins, and rosin resins. Particularly preferably, the tackifier resin(s) is/are selected from the group consisting of aliphatic hydrocarbon resins and phenolic resins.

The rubber mixture of the invention contains 50 to 100 phr of at least one filler. Said filler(s) may be any fillers for rubber mixtures known to those skilled in the art. These fillers include carbon blacks, silicas, aluminosilicates, kaolin, chalk, starch, magnesium oxide, titanium dioxide, rubber gels, fibers (for example aramid fibers, glass fibers, carbon fibers, cellulose fibers), carbon nanotubes (CNT), carbon (for example HTC carbon), graphite, and graphene and also carbon silica dual-phase fillers. All fillers may also be used as mixtures.

If carbon black is present in the rubber mixture, this may be ones having an iodine value in accordance with ASTM D 1510, also known as the iodine absorption value, of between 30 and 250 g/kg, preferably 50 to 200 g/kg, more preferably 80 to 140 g/kg, and a DBP value in accordance with ASTM D 2414 of 50 to 250 ml/100 g, preferably 65 to 160 ml/100 g, more preferably 105 to 145 ml/100 g. The DBP value in accordance with ASTM D 2414 determines the specific absorption volume of a carbon black or of a light-colored filler using dibutyl phthalate. Employable carbon blacks also include “recovered” carbon blacks, i.e. recovered/recycled carbon blacks. The employable carbon blacks may also be oxidized.

If silicas are present in the mixture, they may be any of the silicas known to those skilled in the art that are suitable as filler for tire rubber mixtures. Particular preference is however given to using a finely divided, precipitated silica having a nitrogen surface area (BET surface area) (in accordance with DIN ISO 9277 and DIN 66132) of 35 to 400 m²/g, preferably of 60 to 250 m²/g, more preferably of 70 to 200 m²/g, and even more preferably of 130 to 190 m²/g, and a CTAB surface area (in accordance with ASTM D 3765) of 35 to 400 m²/g, preferably of 60 to 250 m²/g, more preferably of 70 to 200 m²/g, and even more preferably of 130 to 190 m²/g.

Examples of silicas that can be used thus include not only those of the Ultrasil® VN3 (trade name) type from Evonik but also silicas having a comparatively low BET surface area (for example Zeosil® 1115 or Zeosil® 1085 from Solvay) and highly dispersible silicas, so-called HD silicas (for example Zeosil® 1165 MP from Solvay). It is also possible to use silicon dioxide obtained from the residue of combustion of rice hulls.

For good rolling resistance properties in respect of use in vehicle pneumatic tires, it has been found to be advantageous when it contains as filler 5 to 45 phr, preferably 10 to 30 phr, of silica and 20 to 80 phr, preferably 40 to 65 phr, of carbon black.

If silica is present in the rubber mixture, for the improvement of processibility and for attachment of the silica to the rubber in silica-containing mixtures, it is preferable to use at least one silane coupling agent in amounts of 1-15 phf (parts by weight, based on 100 parts by weight of silica) in the rubber mixture. The silane coupling agents may also be used as mixtures.

The expression phf (parts per hundred parts of filler by weight) used in this text is the conventional unit of amount for coupling agents for fillers in the rubber industry. In the context of the present application, phf relates to the silica present, meaning that any other fillers present, such as carbon black, are not included in the calculation of the amount of silane coupling agent.

The silane coupling agents react with the surface silanol groups of the silica or other polar groups during the mixing of the rubber/the rubber mixture (in situ) or in the context of a pretreatment (premodification) performed before addition of the filler to the rubber. Silane coupling agents that may be used here include all silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that after cleavage can optionally undergo a chemical reaction with the double bonds of the polymer. The latter group may for example comprise the following chemical groups: —SCN, —SH, —NH₂ or —Sₓ— (where x=2-8). Silane coupling agents that may be used thus include for example 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of sulfides having 1 to 8 sulfur atoms with varying contents of the various sulfides. TESPT may for example also be added as a mixture with industrial carbon black (trade name X50S from Degussa). Blocked mercaptosilanes as known for example from WO 99/09036 may also be used as silane coupling agent. It is also possible to use silanes as described in WO 2008/083241 A1, WO 2008/083242 A1, WO 2008/083243 A1, and WO 2008/083244 A1. It is possible to use for example silanes sold under the NXT® name in a number of variants by Momentive, USA, or those sold under the VP Si 363 name by Evonik Industries. Also employable are “silated core polysulfides” (SCPs, polysulfides with a silylated core), which are described for example in US20080161477 A1 and EP 2 114 961 B1. Silanes such as those disclosed in WO 2019105614 A1 may also be used.

The rubber mixture may further contain customary additives in customary parts by weight, which are added preferably in at least one preliminary mixing stage during the production of said mixture. These additives include
a) aging inhibitors, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), and 2,2,4-trimethyl-1,2-dihydroquinoline (TMQ),
b) activators, for example zinc oxide and fatty acids (e.g. stearic acid) or zinc complexes, for example zinc ethylhexanoate,
c) waxes,
d) mastication aids, for example 2,2′-dibenzamidodiphenyl disulfide (DBD), and
e) processing aids, for example fatty acid salts, for example zinc soaps, and fatty acid esters and derivatives thereof,
f) plasticizers, such as in particular aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL) preferably having a content of polycyclic aromatics of less than 3% by weight according to method IP 346 or triglycerides, for example rapeseed oil or factices. When using mineral oil this is preferably selected from the group consisting of DAE (distillate aromatic extracts), RAE (residual aromatic extract), TDAE (treated distillate aromatic extracts), MES (mild extracted solvents), and naphthenic oils.
g) further resins other than tackifier resins,
h) substances serving as adhesion systems for the adhesion of rubber mixtures to reinforcing elements.

The proportion of the total amount of further additives is 3 to 150 phr, preferably 3 to 100 phr, and more preferably 5 to 80 phr.

The vulcanization of the rubber mixture is carried out in the presence of sulfur and/or sulfur donors with the aid of vulcanization accelerators, it being possible for some vulcanization accelerators to act simultaneously as sulfur donors. The accelerator is selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators.

Preference is given to using a sulfenamide accelerator selected from the group consisting of N-cyclohexyl-2-benzothiazolesulfenamide (CBS) N,N-dicyclohexylbenzothiazole-2-sulfenamide (DCBS), N,N-dibenzyl-2-benzothiazolesulfenamide (DBBS), benzothiazyl-2-sulfenomorpholide (MBS), N-tert-butyl-2-benzothiazylsulfenamide (TBBS), sulfenamide accelerators such as N-t-butyl-2-benzothiazolesulfenimide (TBSI), and guanidine accelerators such as diphenylguanidine (DPG).

It is also possible for the rubber mixture to comprise vulcanization retardants.

The sulfur donor substance employed may be selected from any of the sulfur donor substances known to those skilled in the art. When the rubber mixture comprises a sulfur donor substance, this is preferably selected from the group consisting of, for example, thiuram disulfides, for example tetrabenzylthiuram disulfide (TBzTD), tetramethylthiuram disulfide (TMTD) or tetraethylthiuram disulfide (TETD), thiuram tetrasulfides, for example dipentamethylenethiuram tetrasulfide (DPTT), dithiophosphates, for example DipDis (bis(diisopropyl)thiophosphoryl disulfide), bis(O,O-2-ethylhexylthiophosphoryl) polysulfide (e.g. Rhenocure SDT 50®, Rheinchemie GmbH), zinc dichloryldithiophosphate (e.g. Rhenocure ZDT/S®, Rheinchemie GmbH) or zinc alkyldithiophosphate, and 1,6-bis(N,N-dibenzylthiocarbamoyldithio) hexane and diaryl polysulfides and dialkyl polysulfides.

Further network-forming systems as obtainable, for example, under the trade names Vulkuren®, Duralink® or Perkalink® or network-forming systems such as those described in WO 2010/049216 A2 may also be used in the rubber mixture. The latter system contains a vulcanizing agent which crosslinks with a functionality of greater than four and at least one vulcanization accelerator.

During production of the rubber mixture it is preferable to add to this, in the final mixing stage, at least one vulcanizing agent selected from the group consisting of sulfur, sulfur donors, vulcanization accelerators, and vulcanizing agents that crosslink with a functionality of greater than four. This makes it possible to produce from the mixed finished mixture, by vulcanization, a sulfur-crosslinked rubber mixture for use in rubber products, especially in pneumatic vehicle tires.

The terms “vulcanized” and “crosslinked” are used synonymously in the context of the present invention.

The rubber mixture is produced by the process customary in the rubber industry in which a preliminary mixture comprising all constituents apart from the vulcanization system (sulfur and vulcanization-influencing substances) is firstly produced in one or more mixing stages. The finished mixture is produced by adding the vulcanization system in a final mixing stage. The finished mixture is processed further, for example by an extrusion operation, and brought into the appropriate shape. This is followed by further processing by vulcanization, wherein sulfur crosslinking takes place due to the vulcanization system added in the context of the present invention.

The rubber mixture can be used for a wide variety of different rubber products. It is preferably used for the production of pneumatic vehicle tires such as car, van, HGV or two-wheeled vehicle tires, the rubber mixture preferably being used in the tread.

In a pneumatic vehicle tire, the tread may consist of a single mixture designed in accordance with the invention. It is however commonplace nowadays for pneumatic vehicle tires to have a tread with what is called a cap/base construction. What is meant here by “cap” is the part of the tread that comes into contact with the road, being arranged radially on the outside (upper tread portion or tread cap). What is meant here by “base” is the part of the tread which is arranged radially on the inside, and hence does not come into contact with the road in driving operation, or does so only at the end of the tire lifetime (lower tread portion or tread base). In the case of a pneumatic vehicle tire having such a cap/base construction, at least the rubber mixture for the base is designed according to claim 1.

The pneumatic vehicle tire of the invention may also have a tread consisting of various tread mixtures arranged alongside one another and/or one on top of another (multicomponent tread).

In the production of the pneumatic vehicle tire, the mixture is preferably brought into the shape of a tread, preferably at least into the shape of a tread base, as the finished mixture prior to vulcanization, and applied in the known manner in the production of the vehicle green tire. The tread, preferably at least the tread base, can also be wound onto a green tire in the form of a narrow strip of rubber mixture.

The invention encompasses all of the advantageous configurations reflected inter alia in the claims. The invention in particular also encompasses configurations that result from combination of different features, for example of constituents of the rubber mixture, with different levels of preference for these features, such that the invention also encompasses a combination of a first feature described as “preferred” or feature described in the context of an advantageous embodiment with a further feature described for example as “particularly preferred”.

The invention will now be illustrated in detail with reference to comparative examples and working examples, which are summarized in Table 1.

The comparative mixtures here are labeled V, the inventive mixture E.

Rubber mixtures were produced in accordance with Table 1. The mixture was produced by the methods customary in the rubber industry under standard conditions in three stages in a laboratory mixer, in which all the constituents apart from the vulcanization system (sulfur and vulcanization-influencing substances) were first mixed in the first mixing stage (preliminary mixing stage). In the second mixing stage the preliminary mixture was mixed again. Addition of the vulcanization system in the third stage (final mixing stage) afforded the finished mixture, which was mixed at 90 to 120° C. For all mixtures, the Mooney viscosity (ML 1+4) was determined in accordance with ASTM D 1646 (2004).

All mixtures were used to produce test specimens by a 20-minute vulcanization under pressure at 160° C., and these test specimens were used to determine the following material properties typical for the rubber industry by the test methods specified hereinbelow:
conditioned Shore A hardness at room temperature (RT) and 70° C. hardness in accordance with DIN ISO 7619-1, preconditioned at 5 MPa ten times and then tested in accordance with ISO 868
rebound resilience at room temperature (RT) in accordance with ISO 4662
stress value at 200% elongation at room temperature (M200 RT) in accordance with DIN 53 504
tensile/tear strength at room temperature in accordance with ISO 37
tensile strain/elongation at break at room temperature in accordance with ISO 37
fracture energy density at room temperature in accordance with ISO 37 based on the volume of the sample

The rubber regenerate 1 was obtained by thermomechanical devulcanization, optionally using diphenyl disulfide as regeneration agent in a kneading device (t<30 min; T=approx. 200° C.; and subsequent filtration) from a rubber mixture consisting essentially of 100% by weight of comminuted treads of HGV radial tires and bus radial tires. Regenerate 1 is commercially available under the trade name Ecorr® RNR30 B01 from Rubber Resources.

The special rubber regenerate 2 used in mixtures according to the invention was produced according to the following process steps in the indicated sequence:
comminuting a rubber mixture consisting essentially of 100% by weight of comminuted treads of HGV radial tires and bus radial tires by means of a cryogenic grinding process (pin mill) to a granulate having a particle size of 0.001 to 0.5 mm,
charging an internal mixer with 90.7% by weight of the comminuted rubber mixture to be regenerated,
heating the comminuted rubber mixture to be regenerated to 60° C.,
adding 2% by weight of carbon black (N121),
adding 5.5% by weight of the regenerating agent bis(triethoxysilyl)propyltetrasulfane (TESPT),
adding 2% by weight of TDAE oil (TDAE=treated aromatic extract),
mixing said constituents to form a rubber regenerate for a period of 20 minutes at a temperature of 100° C.,
cooling the rubber regenerate.

TABLE 1

| | Unit | 1(V) | 2(V) | 3 (V) | 4(V) | 5(V) | 6(V) | 7(E) |
|---|---|---|---|---|---|---|---|---|
| Constituents | | | | | | | | |
| Natural rubber | phr | 100 | 100 | 75 | 75 | 75 | 75 | 75 |
| High-cis BR ^{a} | phr | — | — | 25 | 25 | 25 | 25 | 25 |
| Rubber regenerate 1 | phr | — | — | — | — | — | 20 | — |
| Rubber regenerate 2 | phr | — | 20 | — | 20 | — | — | 20 |
| N339 carbon black | phr | 55 | 55 | 55 | 55 | 55 | 55 | 55 |
| Silica ^{b} | phr | 15 | 15 | 15 | 15 | 15 | 15 | 15 |
| Silane coupling | phr | 1.5 | 1.5 | 1.5 | 1.5 | 1.5 | 1.5 | 1.5 |
| agent^{c} | | | | | | | | |
| Plasticizer oil | phr | 5 | 5 | 5 | 5 | 5 | 5 | 5 |
| Resin^{d} | phr | — | — | — | — | 5 | 5 | 5 |
| Aging inhibitor | phr | 5 | 5 | 5 | 5 | 5 | 5 | 5 |
| Zinc oxide | phr | 3 | 3 | 3 | 3 | 3 | 3 | 3 |
| Stearic acid | phr | 3 | 3 | 3 | 3 | 3 | 3 | 3 |
| Accelerator | phr | 3 | 3 | 3 | 3 | 3 | 3 | 3 |
| Sulfur | phr | 2.5 | 2.5 | 2.5 | 2.5 | 2.5 | 2.5 | 2.5 |
| Properties | | | | | | | | |
| Mooney visc. | MU | 71 | 78 | 81 | 84 | 73 | 68 | 81 |
| (ML1 + 4) | | | | | | | | |
| Shore hardness RT | ShA | 73.9 | 73.8 | 75.2 | 74.0 | 73.5 | 71.6 | 73.1 |
| Shore hardness 70° C. | ShA | 71.3 | 71.4 | 72.5 | 71.8 | 70.0 | 67.8 | 69.3 |
| Rebound resilience | % | 43.8 | 44.4 | 49.8 | 49.3 | 44.7 | 43.2 | 45.5 |
| RT | | | | | | | | |
| Rebound resilience | % | 58.1 | 57.0 | 61.3 | 61.4 | 57.0 | 56.6 | 61.0 |
| 70° C. | | | | | | | | |
| M200 RT | MPa | 16.5 | 15.7 | 16.0 | 15.44 | 13.8 | 11.8 | 13.0 |
| Tensile strength RT | MPa | 18.4 | 17.1 | 13.7 | 16.0 | 17.0 | 15.1 | 17.6 |
| Elongation at break | % | 240 | 234 | 195 | 225 | 257 | 262 | 275 |
| RT | | | | | | | | |
| Fracture energy | J/cm³ | 17 | 15 | 11 | 14 | 17 | 15 | 18 |
| density RT | | | | | | | | |

^{a} Synteca ® 44, from Synthos PBR s.r.o., T_{g} = −105° C., cis content > 95%
^{b} Silica: Ultrasil ® VN 3 GR, from Evonik Industries
^{c}3,3′-Bis(triethoxysilylpropyl) disulfide (TESPD)
^{d}Koresin ®, from BASF, phenolic resin based on butylphenol and acetylene, ring and ball softening point in accordance with DIN 52011 of from 135 to 150° C.

From Table 1 it can be seen that the combination of the special rubber regenerate 2 with the resin in mixtures having a high proportion of natural polyisoprene (see 7 (E)) results in mixtures characterized by good crack resistance—tensile strength is used as a measure of this here—while at the same time exhibiting a low heat buildup. The latter can be correlated with a high rebound resilience at 70° C.

Addition of the rubber regenerate 2 on its own without resin (see 2 (V)) results in a deterioration in crack resistance, whereas the heat buildup remains at a similar level. If natural polyisoprene is partially replaced by polybutadiene (see 3 (V) and 4 (V)), although the heat buildup improves, the crack resistance deteriorates significantly and the tensile strength decreases markedly. Addition of the resin (see 5 (V)) allows the crack resistance to be improved. What was surprising, however, was the interplay of the resin and the special rubber regenerate 2, which results in improved heat buildup and increases the crack resistance still further (see 7 (E)). This could not have been expected from the sum of the individual measures (see 2 (V) and 5 (V)). This effect is moreover achieved only with the special rubber regenerate 2. With a conventional rubber regenerate 1, a marked deterioration is observed in both heat buildup and crack resistance (see 6 (V)).

1. A sulfur-crosslinkable rubber mixture comprising at least the following constituents:
50 to 100 phr (parts by weight, based on 100 parts by weight of all rubbers in the mixture) of natural polyisoprene (NR),
0 to 50 phr of at least one further diene rubber,
5 to 80 phr of at least one rubber regenerate produced using at least one regenerating agent selected from the group consisting of dithiophosphoryl polysulfides and silanes having a polysulfane group from a rubber mixture produced in an internal mixer, where the rubber mixture includes at least 50% by weight of comminuted treads of radial heavy goods vehicle (HGV) tires and/or radial bus tires,
1 to 30 phr of at least one tackifier resin, and
50 to 100 phr of at least one filler.

2. The sulfur-crosslinkable rubber mixture as claimed in claim 1, wherein the rubber mixture it contains
60 to 90 phr of natural polyisoprene and
10 to 40 phr of at least one further diene rubber.

3. The sulfur-crosslinkable rubber mixture as claimed in claim 1, wherein the rubber mixture contains, as at least one further diene rubber, 10 to 40 phr of butadiene rubber (BR).

4. The sulfur-crosslinkable rubber mixture as claimed in claim 1, wherein the rubber mixture contains 5 to 40 phr of at least one rubber regenerate.

5. The sulfur-crosslinkable rubber mixture as claimed in claim 1, wherein the regenerating agent is selected from bis(O,O-2-ethylhexylthiophosphoryl) polysulfide and/or (bis(triethoxysilyl)propyltetrasulfane (TESPT)).

6. The sulfur-crosslinkable rubber mixture as claimed in claim 1, wherein the rubber mixture consists of at least 70% by weight of comminuted treads of radial HGV tires and/or radial bus tires.

7. The sulfur-crosslinkable rubber mixture as claimed in claim 1, wherein the rubber mixture contains 2.5 to 10 phr of at least one tackifier resin.

8. The sulfur-crosslinkable rubber mixture as claimed in claim 1, wherein the tackifier resin(s) has/have a ring and ball softening point in accordance with DIN 52011 of from 50 to 160° C., preferably from 125 to 160° C.

9. The sulfur-crosslinkable rubber mixture as claimed in claim 1, wherein the tackifier resin(s) is/are selected from the group consisting of aliphatic hydrocarbon resins, phenolic resins, terpene resins, terpene-phenol resins, AMS resins, coumarone-indene resins, and rosin resins.

10. The sulfur-crosslinkable rubber mixture as claimed in claim 9, wherein the tackifier resin(s) is/are selected from the group consisting of aliphatic hydrocarbon resins and phenolic resins.

11. The sulfur-crosslinkable rubber mixture as claimed in claim 1, wherein the rubber mixture contains as filler 5 to 45 phr, preferably 10 to 30 phr, of silica and 20 to 80 phr, preferably 40 to 65 phr, of carbon black.

12. A vulcanizate obtained by sulfur vulcanization of at least one rubber mixture as claimed in claim 1.

13. A vehicle tire, wherein the vehicle tire includes at least one vulcanizate as claimed in claim 12 in at least one component.

14. The vehicle tire as claimed in claim 13, wherein the vehicle tire includes the at least one vulcanizate at least in a tread of the tire.

15. The vehicle tire as claimed in claim 14, wherein the vehicle tire includes the at least one vulcanizate in a tread base of the tread.

16. A vehicle tire comprising a vulcanizate in at least one component, the vulcanizate obtained from a sulfur-crosslinkable rubber mixture comprising:
60 to 90 phr (parts by weight, based on 100 parts by weight of all rubbers in the mixture) of natural polyisoprene (NR),
10 to 40 phr of at least one further diene rubber, which is butadiene rubber (BR),
5 to 40 phr of at least one rubber regenerate obtained from a mixture including at least one regenerating agent and at least 70% by weight of comminuted treads of radial heavy goods truck tires and/or radial bus tires, wherein the at least one regenerating agent includes bis(O,O-2-ethylhexylthiophosphoryl) polysulfide and/or (bis(triethoxysilyl)propyltetrasulfane (TESPT)),
2.5 to 10 phr of at least one tackifier resin selected from the group consisting of aliphatic hydrocarbon resins, phenolic resins, terpene resins, terpene-phenol resins, AMS resins, coumarone-indene resins, and rosin resins, and
50 to 100 phr of at least one filler, wherein the at least one filler includes 10 to 30 phr of silica and 20 to 80 phr of carbon black.

17. A method of producing a sulfur-crosslinkable rubber mixture suitable for a tire component, the method comprising:
(i) obtaining at least one rubber regenerate by mixing at least one regenerating agent and at least 50% by weight of comminuted treads of radial heavy goods vehicle tires and/or radial bus tires, wherein the at least one regenerating agent is selected from the group consisting of dithiophosphoryl polysulfides and silanes having a polysulfane group; and
(ii) mixing 5 to 80 phr of the at least one rubber regenerate with at least the following constituents:
50 to 100 phr (parts by weight, based on 100 parts by weight of all rubbers in the mixture) of natural polyisoprene (NR),
0 to 50 phr of at least one further diene rubber,
1 to 30 phr of at least one tackifier resin, and
50 to 100 phr of at least one filler.

18. The method according to claim 17, wherein:
the obtaining the at least one rubber regenerate in (i) includes mixing at least 70% by weight of the comminuted treads and the at least one regenerating agent, and wherein the at least one regenerating agent includes bis(O,O-2-ethylhexylthiophosphoryl) polysulfide and/or (bis(triethoxysilyl)propyltetrasulfane (TESPT)), and
the mixing in (ii) includes mixing 5 to 40 phr of the obtained at least one regenerate with at least:
60 to 90 phr (parts by weight, based on 100 parts by weight of all rubbers in the mixture) of the natural polyisoprene (NR),
10 to 40 phr of the at least one further diene rubber, which is butadiene rubber (BR),
2.5 to 10 phr of the at least one tackifier resin which is selected from the group consisting of aliphatic hydrocarbon resins, phenolic resins, terpene resins, terpene-phenol resins, AMS resins, coumarone-indene resins, and rosin resins, and
50 to 100 phr of the at least one filler, wherein the at least one filler includes 10 to 30 phr of silica and 20 to 80 phr of carbon black.

19. The method according to claim 17 in combination with a step of vulcanizing the produced sulfur-crosslinkable rubber mixture to produce the component of the tire.
